(19) United States
(12) Patent Application Publication
(10) Pub. No.: US 2025/0039060 A1
(43) Pub. Date: Jan. 30, 2025

(54) Traffic Classification Optimization in Communication Networks

(71) Applicant: Telefonaktiebolaget LM Ericsson (publ), Stockholm (SE)

(72) Inventors: Miguel Angel Muñoz De La Torre Alonso, Madrid (ES); Carlota Villasante Marcos, Madrid (ES); Miguel Angel Julian Aguilar, Madrid (ES)

(21) Appl. No.: 18/561,151

(22) PCT Filed: Oct. 8, 2021
(86) PCT No.: PCT/EP2021/077825

§ 371 Date: Nov. 15, 2023

(30) Foreign Application Priority Data
May 20, 2021 (EP) 21382460.0

(51) Int. Cl. H04L 41/142; H04L 43/026

(52) U.S. Cl. CPC H04L 41/142; H04L 43/026

(57) ABSTRACT

A method performed by a network data analytics entity in a communications network comprising receiving from a use plane entity traffic classification information relative to the classification of traffic into an application, the traffic classification information including at least one of an application identifier and a Packet Flow Descriptor (PFD): determining, based on the received traffic classification information, a traffic classification cost indicative of the cost of the classification of traffic into the application in terms of user plane resources usage and/or signaling load; and storing the traffic classification cost along with the application identifier or PFD. The traffic classification information may be indicative of at least one of CPU resources usage, memory resources usage, traffic classification technology, number of flows, number of packets, packet size, traffic volume, flow volume and flow duration.

### TECHNICAL FIELD

The present invention generally relates to traffic classification in communication networks, and more specifically, the invention relates to an optimization of traffic classification in communication networks based on analytics.

### BACKGROUND

The NWDAF (Network Data Analytics Function), whose main procedures are standardized in 3GPP TS 23.288, provides analytics to 5GC (Fifth Generation Core) NFs (Network Functions) and OAM (Operations and Management) systems. Analytics information are either statistical information of the past events, or predictive information. Different NWDAF instances may be present in the 5GC, with possible specializations per type of analytics. The capabilities of a NWDAF instance are described in the NWDAF profile stored in the NRF (Network Repository Function). Each NWDAF instance should provide the list of Analytics Identifiers (ID) that it supports when registering to the NRF, in addition to other NRF registration elements of the NF (Network Function) profile. Other NFs requiring the discovery of an NWDAF instance that provides support for some specific type of analytics may query the NRF and include the Analytics ID(s) that identifies the desired type of analytics for that purpose. The consumers, e.g. 5GC NFs and OAM, decide how to use the data analytics provided by NWDAF.

In 5GC, the detection of applications is done by means of a set of SDF (Service Data Flow) filters, PFD (Packet Flow Descriptor) and/or an application ID. The application is detected at the User Plane using packet header matching, e.g. the packet inspection functionality available in the UPF (User Plane Function), based on the corresponding SDFs or PFDs. The UPF is provisioned with the proper SDFs and/or PFDs for example at the establishment of the data session between the User Equipment (UE) and the Data Network (DN), i.e. the PDU (Packet Data Unit) session establishment procedure in 5GC. The SDFs/PFDs can be also provisioned to the UPF in a parallel procedure, e.g. the PFD management procedures in 5GC. These PFD management procedures are typically handled by the SMF (Session Management Function) and can be of a push or pull nature. In pull procedures, the PFDs for a certain application are requested e.g. by SMF, and in push procedures the PFDs are provided in a proactive manner e.g. to SMF.

Other application detection or traffic classification procedures in UPF include heuristics or Machine Learning (ML)-based mechanisms. These mechanisms match the traffic against patterns or models and produce a classification result which may imply a certain degree of accuracy.

In the UPF, the application detection of traffic classification procedure for a certain application is executed according to a Packet Detection Rule (PDR), which includes an order or precedence of execution. When a packet arrives at UPF, it is matched against the list of PDRs for different applications according to this order or precedence. This order or precedence is defined by the PCC rules that are provisioned to the Session Management Function (SMF) by the Policy Control Function (PCF). Each PCC rule for each application includes a precedence, and this precedence is translated into the PDR order at UPF. At PDU session establishment, based on the subscription data, PCF installs the PCC rules (with their corresponding precedence) and SMF translates them into PDRs (and associated rules: FARs, QERS, URRs, etc.) which are then installed in the UPF.

The precedence of the PCC rules is determined by the PCF on a per subscriber session basis. This precedence is usually static and preconfigured in UDR as subscriber policy data. In the context of 4G/5G networks supporting CUPS, the PCC rules are mapped by SMF into PDRs (and their precedence is directly mapped from PCC rule precedence) and different enforcement actions (FARs, QERs, URRs).

A problematic aspect is that the precedence of the PCC rules has a high relevance for UPF in terms of the resources used for traffic detection and classification, specifically the performance impact (e.g. in terms of CPU and memory) highly depends on the PCC rules precedence value. The PCF is not aware of this aspect. The existing mechanisms to set the precedence values are based on static, local and manual configuration.

UPF evaluates PDRs according to the precedence, which is not optimal since each subscriber has different behavior in terms of the applications used. The PDRs with higher precedence are always executed and evaluated before PDRs of lower precedence. If the applications mostly used, and most of the user traffic is of the applications with PDRs of lower precedence, this results in a significant use of CPU and memory resources at UPF in executing PDRs of higher precedence that are not matched.

This problem is more impactful if the mechanisms used to evaluate the PDRs are based on heuristics or Machine Learning models, which may be much more resource consuming.

### SUMMARY

An object of the invention is to optimize the traffic classification in communication networks by reducing the resources needed at the user plane entities for traffic classification purposes. A first aspect of the invention relates to a method performed by a network data analytics entity and comprises receiving from the use plane entity traffic classification information relative to the classification of traffic into an application, the traffic classification information including at least one of an application identifier and a Packet Flow Descriptor (PFD); determining, based on the received traffic classification information, a traffic classification cost indicative of the cost of the classification of traffic into the application in terms of user plane resources usage and/or signaling load; and storing the traffic classification cost along with the application identifier or PFD, particularly wherein the traffic classification cost is stored in the network data analytics entity or in a user data repository. The traffic classification information may be indicative of at least one of CPU resources usage, memory resources usage, traffic classification technology, number of flows, number of packets, packet size, traffic volume, flow volume and flow duration. The traffic classification technology may be shallow or deep packet inspection, heuristics, or machine learning. The method may further comprise receiving from an analytics consumer an analytics request for the traffic classification cost of an application, including an application identifier or a PFD; and transmitting to the analytics consumer the determined traffic classification cost for the application. The traffic classification information may further comprise a user identifier or a user group identifier; the analytics request may further comprise a user identifier or a user group identifier; and the traffic classification cost transmitted to the analytics consumer may be determined based on the user identifier or the user group identifier. The network data analytics entity may be a Network Data Analytics Function (NWDAF), the user plane entity may be a User Plane Function (UPF), and the user data repository may be a User Data Repository (UDR). The analytics consumer may be a Policy Control Function (PCF).

A second aspect of the invention relates to a method performed by a network entity and comprises receiving from a control plane entity information indicative of the traffic classification cost associated to the traffic classification of an application; determining based on the received information the order or priority of the traffic classification rules of the application; and enforcing the classification of the traffic of the application according to the determined order or priority. The network entity may be a policy control entity and the enforcing step comprises transmitting to a session management function a policy rule relative to the application along with the determined order or priority. The policy control entity may be a Policy Control Function (PCF). The network entity may be a user plane entity and the enforcing step comprises ordering the traffic classification rules in the user plane entity. The user plane entity may be a User Plane Function (UPF). The order or priority may be the precedence associated to the policy rule. The method may further comprise transmitting to the control plane entity a request for the traffic classification cost associated to the traffic classification of an application, including an application identifier or a Packet Flow Descriptor (PFD); receiving from the control plane entity the traffic classification cost associated to the traffic classification of an application. The control plane entity may be a Network Data Analytics Function (NWDAF), or a User Data Repository (UDR).

Other aspects of the invention relate to mobile network nodes, particularly a network data analytics entity, a policy control entity, and a user plane entity, each configured to perform the respective methods as described herein. The network data analytics entity may be a NWDAF, the policy control entity may be a PCF, and the user plane entity may be a UPF. Other aspects of the invention relate to computer program and computer program products.

Advantageously, the solution disclosed herein allows the network operator to automate the process for defining order, priority or precedence of the traffic classification rules on a per subscriber (and subscriber session) basis. The solution allows the network operator to set the precedence of the PCC rules and/or the order or priority of the traffic classification rules at the UPF on a per subscriber basis, minimizing the performance impacts (in terms of CPU and Memory) in the UPF relative to the detection and classification of user traffic.

Further advantageously, the solution disclosed herein allows the network operator to improve the network performance (at UDR, PCF, SMF and UPF nodes and at the interfaces between them, specifically N7 and N4) by optimizing the number of PCC rules installed on a per user's PDU session in the context of 4G/5G networks, since based on the proposed solution the network operator may decide to reduce the number of the traffic classification and/or PCC rules based on their associated traffic classification cost.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The invention may best be understood by referring to the following description and accompanying drawings that are used to illustrate particular embodiments of the invention. In the drawings:

FIG. 1 is a networked system in accordance with particular embodiments of the solution described herein;

FIG. 2 is a signaling diagram illustrating a procedure according to particular embodiments of the solution described herein;

FIG. 3 is a flowchart illustrating a method performed by a mobile network node according to particular embodiments of the solution described herein;

FIG. 4 is a flowchart illustrating a method performed by a mobile network node according to particular embodiments of the solution described herein;

FIG. 5 is a block diagram of a mobile network node configured in accordance with particular embodiments of the solution described herein;

FIG. 6 is a block diagram of a mobile network node configured in accordance with particular embodiments of the solution described herein;

FIG. 7 is a block diagram of a mobile network node configured in accordance with particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

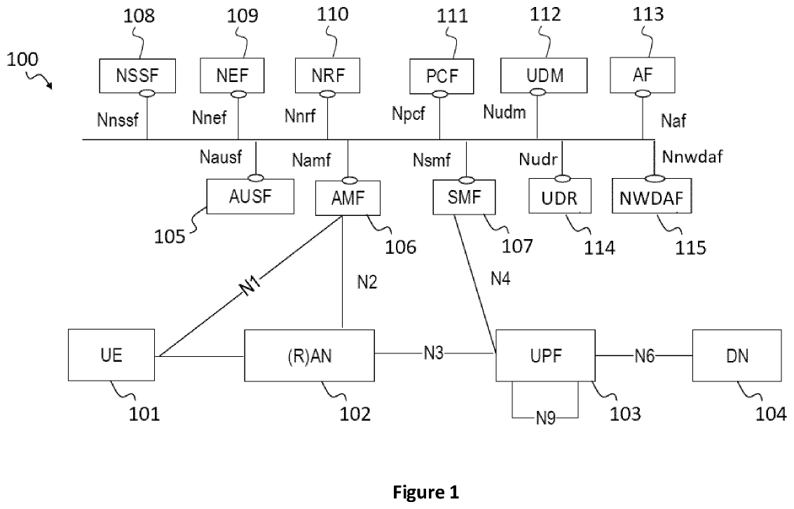

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110, User Data Repository (UDR) 114, Network Data Analytics Function (NWDAF) 115 and Data Network (DN) 104. In some example implementations of embodiments of the present disclosure, an AMF 106, SMF 107, UPF 103, PCF 111, AUSF 105, NRF 110, UDM 112, NEF 109, AF 113, UDR 114, NWDAF 115, and NSSF 108 are each considered to be an NF. One or more additional instances of the network functions (NF) may be incorporated into the networked system.

The solution described herein aims to optimize the traffic classification in communication networks by reducing the resources needed at the user plane entities for traffic classification purposes.

The solution is based on a definition of a new type of analytic relative to the traffic classification cost, which allows the mobile network operator (MNO) to automate the process of defining the PCC rule precedence on a per subscriber session basis and to optimize the handling of the PCC rules, specifically by allowing to determine the optimal precedence values and minimizing the performance impacts (in terms of CPU and memory) in the UPF relative to the detection and classification of user traffic. The mechanism also allows to determine the order or priority of the traffic classification rules at the User Plane Function UPF). In the existing solutions the order or priority follows the precedence value of the corresponding PCC rule. The mechanism proposed herein also allows to determine this order at the UPF irrespective of the precedence set by the policy control function.

The analytic is produced by the Network Data Analytics Function (NWDAF). The proposed mechanism is as follows:
An analytics consumer (any NF, e.g. PCF or OAM) subscribes to NWDAF related to the traffic classification cost analytic (e.g. Analytic-ID=Traffic Classification Cost) for one/several/any UE-ID, and for one or several App-IDs.
The NWDAF triggers data collection from UPF to retrieve information relative to the traffic classification on a per App-ID basis. The UPF may also provide information including a relative or partial cost on a per App-ID basis.
The NWDAF produces the analytic based on the data collected from UPF, and obtains as analytics result the following:
   The traffic classification cost analytic for the application, or a list of tuples (Traffic Classification Cost, App-ID), where the Traffic Classification Cost is a metric (e.g. an integer value) which represents the cost for classifying traffic for the corresponding App-ID.
   As an example, as analytic result, the NWDAF might have obtained the traffic classification cost for 4 applications for a certain UE-ID:
      Traffic Classification Cost=0.73 for App-ID=A
      Traffic Classification Cost=0.24 for App-ID=B
      Traffic Classification Cost=0.57 for App-ID=C
      Traffic Classification Cost=0.36 for App-ID=D
   Where the Traffic classification cost may be an absolute or relative value.
The analytics consumer (e.g. OAM, PCF) applies the corresponding actions based on the analytic result, e.g.:
   Storing in UDR the information of the tuples (Traffic Classification Cost, App-ID), so it can be used by PCF as input to set the PCC rules precedence for the App-IDs for PDU sessions of the UE-ID (e.g. to set a higher precedence for the PCC rule/s for the App-ID/s which have a higher Traffic Classification Cost value).
   For ongoing PDU sessions, updating the PCC rules, e.g. if the Consumer (PCF) has currently installed a set of PCC rules (with their corresponding static precedence) for a certain UE-ID session, and the analytic result's Traffic Classification Cost for the App-IDs shows a different ordering vs the one indicated by the currently installed PCC rules precedence, PCF might update the PCC rules precedence according to the analytic result.

The method disclosed herein is performed by a network data analytics entity, a policy control entity, and a user plane entity. The network data analytics entity may be a NWDAF 115, the policy control entity may be a PCF 111, and the user plane entity may be a UPF 103.

One aspect of the method is performed at the network data analytics entity and comprises receiving from the use plane entity traffic classification information relative to the classification of traffic into an application, the traffic classification information including at least one of an application identifier and a Packet Flow Descriptor (PFD); determining, based on the received traffic classification information, a traffic classification cost indicative of the cost of the classification of traffic into the application in terms of user plane resources usage and/or signaling load; and storing the traffic classification cost along with the application identifier or PFD, particularly wherein the traffic classification cost is stored in the network data analytics entity or in a user data repository. The traffic classification information may be indicative of at least one of CPU resources usage, memory resources usage, traffic classification technology, number of flows, number of packets, packet size, traffic volume, flow volume and flow duration. The traffic classification technology may be shallow or deep packet inspection, heuristics, or machine learning. The method may further comprise receiving from an analytics consumer an analytics request for the traffic classification cost of an application, including an application identifier or a PFD; and transmitting to the analytics consumer the determined traffic classification cost for the application. The traffic classification information may further comprise a user identifier or a user group identifier; the analytics request may further comprise a user identifier or a user group identifier; and the traffic classification cost transmitted to the analytics consumer may be determined based on the user identifier or the user group identifier. The network data analytics entity may be a Network Data Analytics Function (NWDAF), the user plane entity may be a User Plane Function (UPF), and the user data repository may be a User Data Repository (UDR). The analytics consumer may be a Policy Control Function (PCF).

A second aspect of the method is performed by a network entity and comprises receiving from a control plane entity information indicative of the traffic classification cost associated to the traffic classification of an application; determining based on the received information the order or priority of the traffic classification rules of the application; and enforcing the classification of the traffic of the application according to the determined order or priority. The network entity may be a policy control entity and the enforcing step comprises transmitting to a session management function a policy rule relative to the application along with the determined order or priority. The policy control entity may be a Policy Control Function (PCF). The network entity may be a user plane entity and the enforcing step comprises ordering the traffic classification rules in the user plane entity. The user plane entity may be a User Plane Function (UPF). The order or priority may be the precedence associated to the policy rule. The method may further comprise transmitting to the control plane entity a request for the traffic classification cost associated to the traffic classification of an application, including an application identifier or a Packet Flow Descriptor (PFD); receiving from the control plane entity the traffic classification cost associated to the traffic classification of an application. The control plane entity may be a Network Data Analytics Function (NWDAF), or a User Data Repository (UDR).

The traffic classification technology comprises any technology used to classify traffic into an application. Classifying traffic may comprise determining the application (e.g. App-ID) to which a certain traffic (e.g. a traffic packet or PDU) belongs to.

The traffic classification technology may comprise shallow or deep packet inspection (SPI, DPI), heuristics, or machine learning. Heuristics may comprise any deterministic or non-deterministic traffic classification based on specific patterns or traffic signatures. Machine learning may comprise any artificial intelligence technology, e.g. neural networks, or deep learning mechanisms.

The traffic classification technology may comprise collaborative mechanisms, e.g. a QUIC client sharing the App-ID to the QUIC Proxy and directly classifying all flows into the App-ID.

This disclosure also provides mobile network nodes, particularly a network data analytics entity 500, a policy control entity 600, and a user plane entity 700, each configured to perform the respective methods as described herein. This disclosure also provides the corresponding computer program and computer program products comprising code, for example in the form of a computer program, that when run on processing circuitry of the mobile network nodes causes the mobile network nodes to perform the disclosed methods.

Advantageously, the solution disclosed herein allows the network operator to automate the process for defining order, priority or precedence of the traffic classification rules on a per subscriber (and subscriber session) basis. The solution allows the network operator to set the precedence of the PCC rules and/or the order or priority of the traffic classification rules at the UPF on a per subscriber basis, minimizing the performance impacts (in terms of CPU and Memory) in the UPF relative to the detection and classification of user traffic.

Further advantageously, the solution disclosed herein allows the network operator to improve the network performance (at UDR, PCF, SMF and UPF nodes and at the interfaces between them, specifically N7 and N4) by optimizing the number of PCC rules installed on a per user's PDU session in the context of 4G/5G networks, since based on the proposed solution the network operator may decide to reduce the number of the traffic classification and/or PCC rules based on their associated traffic classification cost.

Hereinafter, drawings showing examples of embodiments of the solution are described in detail.

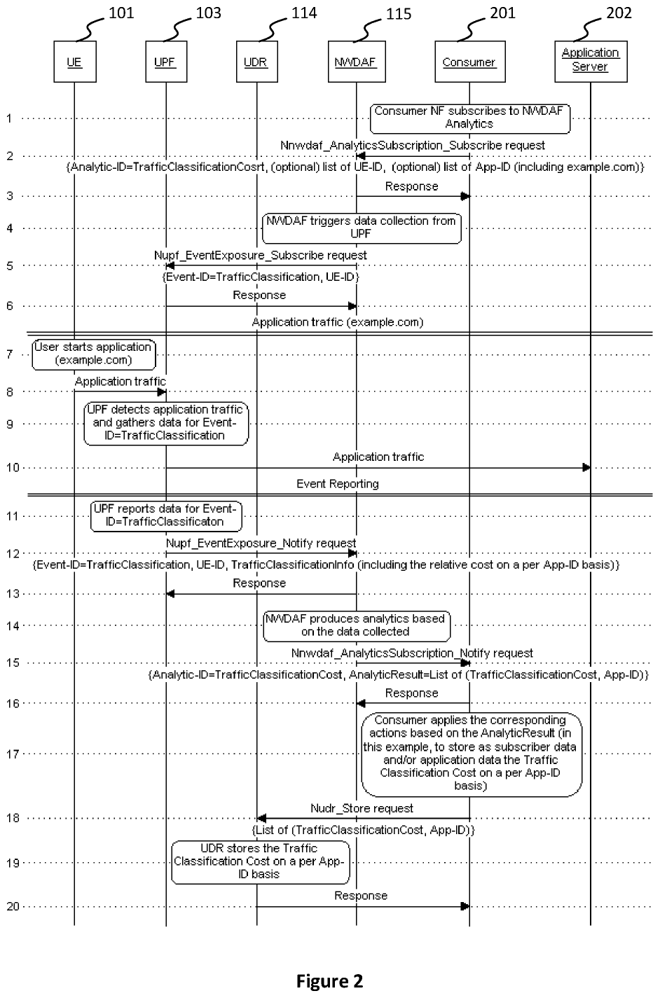

FIG. 2 is a signaling diagram illustrating a procedure for determining traffic classification cost in a communications network. The procedure is performed by a User Equipment (UE) 101, a UPF 103, a UDR 114, a NWDAF 115 an analytics consumer 201 and an application server 202. The analytics consumer may be any NF within the communications system 100.

In steps 1 and 2, a consumer (any NF, e.g. PCF or OAM) subscribes to a new analytic (e.g. Analytic-ID=Traffic Classification Cost) to NWDAF, by triggering a Nnwdaf_AnalyticsSubscription_Subscribe request message including the following parameters:
Analytic-ID, e.g. Analytic-ID=Traffic Classification Cost.
UE-ID or list of UE-ID, UE-Group-ID, or list of UE-Group-ID. This indicates the UE(s) which are the target for this analytic. When not present, any UE applies.
App-ID or list of App-ID. This indicates the App-ID(s) which are the target for this analytic. When not present, a default list of App-IDs applies (e.g. locally configured at NWDAF or UPF).

In step 3, the NWDAF answers the request message in Step 2 with a successful response (accepting the request).

In steps 4 and 5, the NWDAF triggers data collection from the UPF to retrieve information relative to traffic classification information for a UE-ID. The NWDAF triggers a Nupf_EventExposure_Subscribe request message including the following parameters:
Event-ID, e.g. Event-ID=Traffic Classification
UE-ID. This indicates the target UE/s for this event.

The NWDAF may perform data collection from UPF by using existing mechanisms, e.g. those proposed in 3GPP TR 23.700-91 (e.g. through SMF or directly, assuming a service based UPF).

In step 6, the UPF answers the request message in Step 5 with a successful response (accepting the request).

In step 7, the user starts an application.

In step 8, the UE sends application traffic.

In steps 9 and 10, the UPF detects the application traffic and gathers the traffic classification information. The UPF may store the following information:
App-ID
Relative cost for the App-ID). This is a metric (or a set of metrics) calculated by the UPF which indicates how much CPU and memory resources it implies to classify traffic for the App-ID. This may depend on different factors, for example:
   The mechanism to detect and classify each App-ID (e.g. a ML model based on the evaluation of a certain number (X) of features, SPI based on a number (Y) of server IPs, DPI based on a number (Z) of URLs/SNIs, Heuristics based on a number (N) of metrics like bit patterns and/or bit rate ranges, etc.). Specifically, the CPU and Memory cost for detection and classification using the above mechanism.
   Number of flows for the App-ID
   Number of packets and average packet size for the App-ID
   Traffic volume for the App-ID
   For each detected packet or flow:
      Timestamp (indicating the start and stop time for the flow) and duration
      5-tuple
   Volume (in bytes and/or packets) and optionally differentiating uplink and downlink volume
   Number of packets and average packet size

In steps 11 and 12, the UPF reports (e.g. periodic reporting) the data for the corresponding Event-ID, e.g. Event-ID=TrafficClassification. In order to do that, the UE notifies the NWDAF by triggering Nupf_EventExposure_Notify request message including the following parameters:
Event-ID, e.g. Event-ID=TrafficClassification
UE-ID.
Traffic Classification Information. This includes the following information:
   App-ID
   Metric (or a set of metrics) calculated by the UPF which is indicative of the traffic classification cost, e.g. how much CPU and memory resources it implies to classify traffic for the App-ID. This depends on different factors. This set of metrics may comprise: Mechanism to detect and classify each App-ID (e.g. a ML model based on the evaluation of a certain number of features, SPI (Shallow Packet Inspection), e.g. based on a number of server IPs, DPI (Deep Packet Inspection), e.g. based on a number of URLs/SNIs, Heuristics, e.g. based on a number of metrics like bit patterns and/or bit rate ranges, etc. The UPF also includes the CPU and Memory usage for detection and classification using the above mechanism.
   Number of flows for the App-ID
   Number of packets and average packet size for the App-ID
   Traffic volume for the App-ID
   For each detected flow:
      Timestamp (indicating the start and stop time for the flow) and duration
      5-tuple
      Volume (in bytes and/or packets) and optionally differentiating uplink and downlink volume
      Number of packets and average packet size

In step 13, the NWDAF answers the message in Step 12 with a successful response.

In step 14, the NWDAF produces analytics based on the data collected from UPF. As an example, NWDAF might run the following logic:
NWDAF accumulates the (e.g. periodic) UPF reports, specifically by accumulating the metric/s values (e.g. CPU cost and Memory cost) for each App-ID and then it applies for example a linear function with weight factors. For example:
   “cpu_weight”: 1.0,
   “mem_weight”: 0.5,
   “number_of_flows_weight”: 0.8,
   “number_of_packets_weight”: 0.3,
   “volume_weight”: 0.1

The NWDAF may also apply non-linear correlations between the collected metrics, e.g. based on non-linear functions. The NWDAF may also apply mathematical or Machine Learning models to the collected data.

For example, the Traffic Classification Cost for each App-ID might be calculated as follows: Traffic Classification Cost for App-ID=(cpu_weight*CPU cost for App-ID)+(mem_weight*Memory cost for App-ID)+(number_of_flows_weight*number_of_flows for App-ID)+number_of_packets_weight*number_of_packets for App-ID)+(volume_weight*UL/DL volume for App-ID)+ . . .

Based on the above, the NWDAF retrieves and stores the following information as analytics result:
Traffic Classification Cost and App-ID, or a list of tuples (Traffic Classification Cost, App-ID), where Traffic Classification Cost is a metric (e.g. an integer value) which represents the cost for classifying traffic for the corresponding App-ID.

In step 15, the NWDAF notifies the consumer by triggering a

Nnwdaf_AnalyticsSubscription_Notify request message including the following parameters:
Analytic-ID, e.g. Analytic-ID=Traffic Classification Cost.
Analytic Result. This includes the following information:
   Traffic Classification Cost and App-ID, or a list of tuples (Traffic Classification Cost, App-ID), where Traffic Classification Cost is a metric (e.g. an integer value) which represents the cost for classifying traffic for the corresponding App-ID.

In step 16, the consumer answers the message in the previous step with a successful response.

In steps 17 and 18, the consumer applies the corresponding actions based on the Analytic Result (e.g. to store as subscriber data and/or application data the Traffic Classification Cost on a per App-ID basis). In order to do this, the consumer triggers towards UDR a Nudr_Store request message including the following parameters:
Traffic Classification Cost and App-ID, or a list of tuples (Traffic Classification Cost, App-ID), where Traffic Classification Cost is a metric (e.g. an integer value) which represents the cost for classifying traffic for the corresponding App-ID.

In step 19, the UDR stores the Traffic Classification Cost on a per App-ID basis as subscriber data and/or application data.

In step 20, the UDR answers the message in the previous step with a successful response.

The consumer (e.g. PCF or OAM) may trigger different actions based on the Analytic Result, for example:
Update the PCC rules on a per PDU session basis, e.g. if the Consumer (PCF) has previously installed a set of PCC rules (with their corresponding precedence) for a certain UE-ID session and the Traffic Classification Cost for the App-ID shows a different ordering vs the one indicated by the currently installed PCC rules precedence, PCF might update the PCC rules precedence according to the analytic result.
The same applies for new PDU sessions, i.e. the PCF might install the PCC rules and precedence according to the Analytic Result, e.g. setting a higher precedence for the PCC rule/s for the App-ID/s which have a higher Traffic Classification Cost value.

The NWDAF might either be a central NDWAF or might be a local NWDAF, e.g. co-located with the UPF.

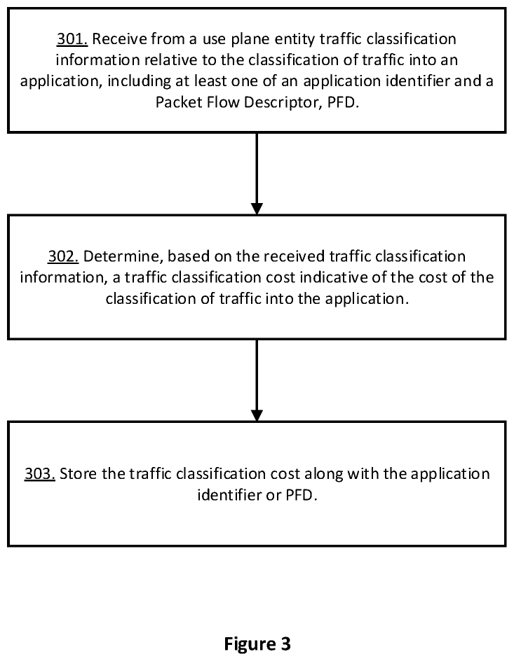

FIG. 3 is a flowchart illustrating a method performed by a network data analytics entity for determining traffic classification cost in a communications network. The network data analytics entity may be a NWDAF 115.

In step 301, the network data analytics entity receives from a use plane entity traffic classification information relative to the classification of traffic into an application, the traffic classification information including at least one of an application identifier and a Packet Flow Descriptor, PFD;

In step 302, the network data analytics entity determines, based on the received traffic classification information, a traffic classification cost indicative of the cost of the classification of traffic into the application in terms of user plane resources usage and/or signaling load; In step 303, the network data analytics entity stores the traffic classification cost along with the application identifier or PFD, particularly wherein the traffic classification cost is stored in the network data analytics entity or in a user data repository.

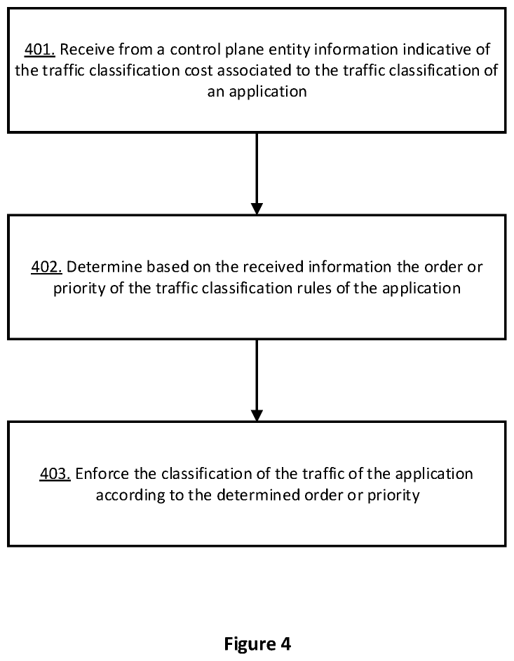

FIG. 4 is a flowchart illustrating a method performed by a network entity for optimizing traffic classification in a communications network. The network entity may be a PCF 111 or a UPF 103.

In step 401, the network entity receives from a control plane entity information indicative of the traffic classification cost associated to the traffic classification of an application;

In step 402, the network entity determines based on the received information the order or priority of the traffic classification rules of the application;

In step 403, the network entity enforces the classification of the traffic of the application according to the determined order or priority. In this step, the network entity may perform the enforcing by transmitting a policy rule or PCC rule (e.g. if the network entity is a PCF) or by ordering, sorting or prioritizing traffic classification rules (e.g. if the network entity is a UPF).

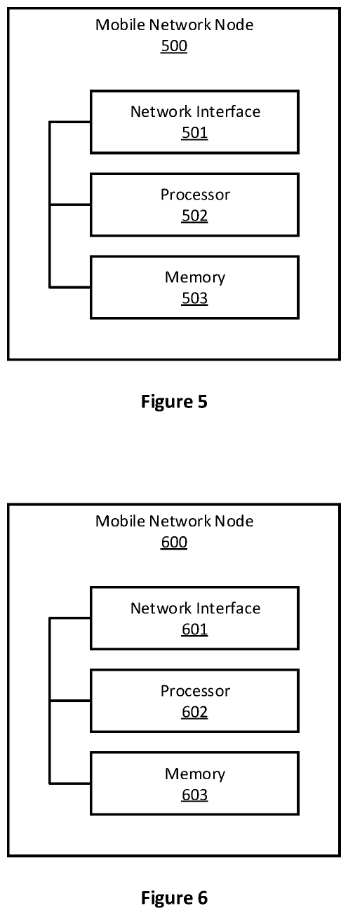

FIG. 5 is a block diagram illustrating elements of a mobile network node 500 of a mobile communications network. In some embodiments, the mobile network node 500 is a network data analytics entity or NWDAF 115. As shown, the mobile network node may include network interface circuitry 501 (also referred to as a network interface) configured to provide communications with other nodes of the core network and/or the network. The mobile network node may also include a processing circuitry 502 (also referred to as a processor) coupled to the network interface circuitry, and memory circuitry 503 (also referred to as memory) coupled to the processing circuitry. The memory circuitry 503 may include computer readable program code that when executed by the processing circuitry 502 causes the processing circuitry to perform operations according to embodiments disclosed herein. According to other embodiments, processing circuitry 502 may be defined to include memory so that a separate memory circuitry is not required. As discussed herein, operations of the mobile network node may be performed by processing circuitry 502 and/or network interface circuitry 501. For example, processing circuitry 502 may control network interface circuitry 501 to transmit communications through network interface circuitry 501 to one or more other network nodes and/or to receive communications through network interface circuitry from one or more other network nodes. Moreover, modules may be stored in memory 503, and these modules may provide instructions so that when instructions of a module are executed by processing circuitry 502, processing circuitry 502 performs respective operations (e.g., operations discussed below with respect to Example Embodiments relating to core network nodes).

FIG. 6 is a block diagram illustrating elements of a mobile network node 600 of a mobile communications network. In some embodiments, the mobile network node 600 is a policy control entity or PCF 111. As shown, the mobile network node may include network interface circuitry 601 (also referred to as a network interface) configured to provide communications with other nodes of the core network and/or the network. The mobile network node may also include a processing circuitry 602 (also referred to as a processor) coupled to the network interface circuitry, and memory circuitry 603 (also referred to as memory) coupled to the processing circuitry. The memory circuitry 603 may include computer readable program code that when executed by the processing circuitry 602 causes the processing circuitry to perform operations according to embodiments disclosed herein. According to other embodiments, processing circuitry 602 may be defined to include memory so that a separate memory circuitry is not required. As discussed herein, operations of the mobile network node may be performed by processing circuitry 602 and/or network interface circuitry 601. For example, processing circuitry 602 may control network interface circuitry 601 to transmit communications through network interface circuitry 601 to one or more other network nodes and/or to receive communications through network interface circuitry from one or more other network nodes. Moreover, modules may be stored in memory 603, and these modules may provide instructions so that when instructions of a module are executed by processing circuitry 602, processing circuitry 602 performs respective operations (e.g., operations discussed below with respect to Example Embodiments relating to core network nodes).

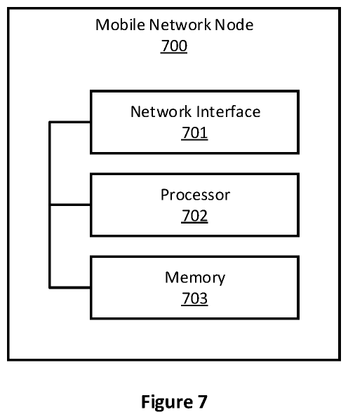

FIG. 7 is a block diagram illustrating elements of a mobile network node 700 of a mobile communications network. In some embodiments, the mobile network node 700 is a user plane entity or UPF 103. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

1-20. (canceled)

21. A method, performed by a network data analytics entity for determining traffic classification cost in a communications network, the method comprising:
receiving, from a user plane entity, traffic classification information relative to a classification of traffic into an application, the traffic classification information including at least one of an application identifier and a Packet Flow Descriptor (PFD);
determining, based on the received traffic classification information, a traffic classification cost indicative of the cost of the classification of traffic into the application in terms of user plane resources usage and/or signaling load; and
storing the traffic classification cost along with the application identifier or the PFD, wherein the traffic classification cost is stored in the network data analytics entity or in a user data repository.

22. The method of claim 21, wherein the traffic classification information is indicative of at least one of CPU resources usage, memory resources usage, traffic classification technology, number of flows, number of packets, packet size, traffic volume, flow volume and flow duration.

23. The method of claim 22, wherein the traffic classification technology comprises shallow packet inspection, deep packet inspection, heuristics, machine learning or deep learning.

24. The method of claim 21, further comprising:
receiving, from an analytics consumer, an analytics request for the traffic classification cost of an application, including an application identifier or the PFD; and
transmitting, to the analytics consumer, the determined traffic classification cost for the application.

25. The method of claim 24, wherein:
the traffic classification information further comprises a user identifier or a user group identifier;
the analytics request further comprises a user identifier or a user group identifier; and
the traffic classification cost transmitted to the analytics consumer is determined based on the user identifier or the user group identifier.

26. The method of claim 24, wherein the analytics consumer is a Policy Control Function (PCF).

27. The method of claim 21, wherein the network data analytics entity is a Network Data Analytics Function (NWDAF), the user plane entity is a User Plane Function (UPF) and the user data repository is a User Data Repository (UDR).

28. A method, performed by a network entity, for traffic classification optimization in a communications network, the method comprising:
receiving, from a control plane entity, information indicative of the traffic classification cost associated to the traffic classification of an application;
determining, based on the received information, an order or priority of traffic classification rules of the application; and
enforcing the classification of the traffic of the application according to the determined order or priority.

29. The method of claim 28, wherein the network entity is a policy control entity and the enforcing comprises transmitting to a session management function a policy rule relative to the application along with the determined order or priority.

30. The method of claim 29, wherein the policy control entity is a Policy Control Function (PCF).

31. The method of claim 29 to the preceding claim, wherein the order or priority is a precedence associated to the policy rule.

32. The method of claim 28, wherein the network entity is a user plane entity and the enforcing comprises ordering the traffic classification rules in the user plane entity.

33. The method of claim 32, wherein the user plane entity is a User Plane Function (UPF).

34. The method of claim 28, further comprising:
transmitting to the control plane entity a request for the traffic classification cost associated to the traffic classification of an application, including an application identifier or a Packet Flow Descriptor (PFD); and
receiving from the control plane entity the traffic classification cost associated to the traffic classification of an application.

35. The method of claim 28, wherein the control plane entity is a Network Data Analytics Function (NWDAF) or a User Data Repository (UDR).

36. A network data analytics entity for determining traffic classification cost in a communications network, the network data analytics entity comprising:
a processor and a memory, the memory containing instructions executable by the processor such that the network data analytics entity is configured to:
receive, from a user plane entity, traffic classification information relative to a classification of traffic into an application, the traffic classification information including at least one of an application identifier and a Packet Flow Descriptor (PFD);
determine, based on the received traffic classification information, a traffic classification cost indicative of the cost of the classification of traffic into the application in terms of user plane resources usage and/or signaling load; and
store the traffic classification cost along with the application identifier or PFD, particularly wherein the traffic classification cost is stored in a network data analytics entity or in a user data repository.

37. The network data analytics entity of claim 36, wherein the traffic classification information is indicative of at least one of CPU resources usage, memory resources usage, traffic classification technology, number of flows, number of packets, packet size, traffic volume, flow volume and flow duration.

38. The network data analytics entity of claim 37, wherein the traffic classification technology comprises shallow packet inspection, deep packet inspection, heuristics, machine learning or deep learning.

39. A network entity for determining traffic classification cost in a communications network, the network entity comprising:
a processor and a memory, the memory containing instructions executable by the processor such that the network entity is configured to:
receive, from a control plane entity, information indicative of the traffic classification cost associated to the traffic classification of an application;
determine based on the received information an order or priority of traffic classification rules of the application; and
enforce the classification of the traffic of the application according to the determined order or priority.

40. The network entity of claim 39, wherein:
the network entity is a policy control entity; and
to enforce the classification, the network entity is configured to transmit, to a session management function, a policy rule relative to the application along with the determined order or priority.
